(19) United States
(12) Patent Application Publication
(10) Pub. No.: US 2025/0000004 A1
(43) Pub. Date: Jan. 2, 2025

(54) CROP FEELER DEVICE FOR MACHINE ROW GUIDANCE

(71) Applicant: Deere & Company, Moline, IL (US)

(72) Inventor: Mark E. Barker, Johnston, IA (US)

(21) Appl. No.: 18/344,942

(22) Filed: Jun. 30, 2023

(51) Int. Cl. A01B 69/04; A01D 41/127

(52) U.S. Cl. CPC A01B 69/008; A01D 41/1278; B62D 6/001

(57) ABSTRACT

A crop feeler device comprising a rod. A base is coupled to the rod. A housing is positioned in a facing relationship with the base. The base is configured to pivot in two opposing directions relative to the housing. A compression device is positioned within a portion of the housing. A guide is positioned within a portion of the housing and in a facing relationship with the compression device. A cable is coupled to at least one of the rod or the base and to the guide. A sensor is positioned to measure a sensing distance from the sensor to at least one of the guide, the cable, or the compression device as the compression device is compressed as the base pivots relative to the housing.

### FIELD OF THE DISCLOSURE

The present disclosure generally relates to machine row guidance and more particularly to a device and method for sensing a crop for crop row guidance for an agricultural work vehicle or machine.

### BACKGROUND OF THE DISCLOSURE

In order to maintain an agricultural work vehicle in a series of crop rows, an operator commonly has to manually steer the work vehicle or a crop feeler device can be used that outputs a non-linear signal that is interpreted to provide a steering signal to help steer the work vehicle.

### SUMMARY OF THE DISCLOSURE

In one embodiment, a crop feeler device is disclosed. The crop feeler device comprises a rod. A base is coupled to the rod. A housing is positioned in a facing relationship with the base. The base is configured to pivot in two opposing directions relative to the housing. A compression device is positioned within a portion of the housing. A guide is positioned within a portion of the housing and in a facing relationship with the compression device. A cable is coupled to at least one of the rod or the base and to the guide. A sensor is positioned to measure a sensing distance from the sensor to at least one of the guide, the cable, or the compression device as the compression device is compressed as the base pivots relative to the housing.

In another embodiment, an agricultural work vehicle is disclosed. The agricultural work vehicle comprises a steering device configured to steer the agricultural work vehicle. A crop feeler device comprises a rod configured to contact a crop, a base coupled to the rod, a housing positioned in a facing relationship with the base, the base configured to pivot in two opposing directions relative to the housing, a compression device positioned within a portion of the housing, a guide positioned within a portion of the housing and in a facing relationship with the compression device, a cable coupled to at least one of the rod or the base and to the guide, and a sensor positioned to measure a sensing distance from the sensor to at least one of the guide, the cable, or the compression device as the compression device is compressed as the base pivots relative to the housing, and provide a signal, and a controller communicatively coupled to the sensor, the controller comprising a data storage device and an electronic data processor, the data storage device configured for storing instructions that are executable by the electronic data processor to cause the electronic data processor to receive the signal, determine a steering output, and provide a steering signal to the steering device to steer the agricultural work vehicle.

In yet another embodiment, a method for controlling an agricultural work vehicle is disclosed. The agricultural work vehicle comprises a steering device configured to steer the agricultural work vehicle. The method comprises providing a crop feeler device comprising a rod configured to contact a crop, a base coupled to the rod, a housing positioned in a facing relationship with the base, the base configured to pivot in two opposing directions relative to the housing, a compression device positioned within a portion of the housing, a guide positioned within a portion of the housing and in a facing relationship with the compression device, a cable coupled to at least one of the rod or the base and to the guide, and a sensor positioned to measure a sensing distance from the sensor to at least one of the guide, the cable, or the compression device as the compression device is compressed as the base pivots relative to the housing, and provide a signal. The method further comprises receiving the signal, determining a steering output, and providing a steering signal to the steering device to steer the agricultural work vehicle.

Other features and aspects will become apparent by consideration of the detailed description and accompanying drawings.

### BRIEF DESCRIPTION OF THE DRAWINGS

FIG. 1 is a side view of an agricultural work vehicle according to one embodiment;

FIG. 2 is a side view of an agricultural work vehicle according to another embodiment;

FIG. 3 is a partial front view of an agricultural work vehicle comprising a crop feeler device according to the embodiment of FIG. 2;

FIG. 4 is a side view of an agricultural work vehicle according to yet another embodiment;

FIG. 5 is a perspective view of a portion of the agricultural work vehicle of the embodiment of FIG. 4;

FIG. 6 is a partial sectioned view of the crop feeler device of FIG. 3;

FIG. 7 is a partial view of the crop feeler device of FIG. 3;

FIG. 8 is a partial view of the crop feeler device of FIG. 3;

FIG. 9 is a block diagram of an agricultural work vehicle; and

FIG. 10 is a flow diagram of a method of controlling the agricultural work vehicle.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Further embodiments of the invention may include any combination of features from one or more dependent claims, and such features may be incorporated, collectively or separately, into any independent claim.

### DETAILED DESCRIPTION

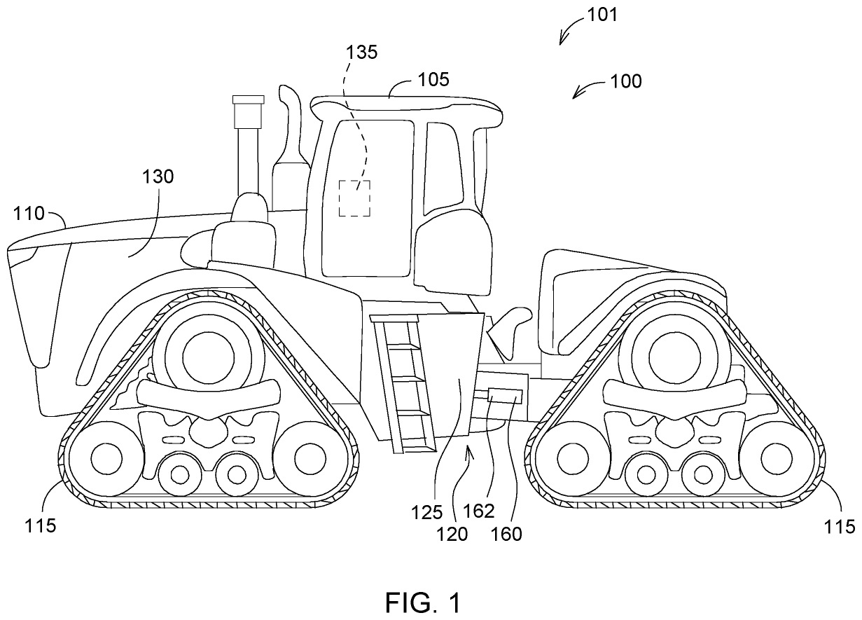

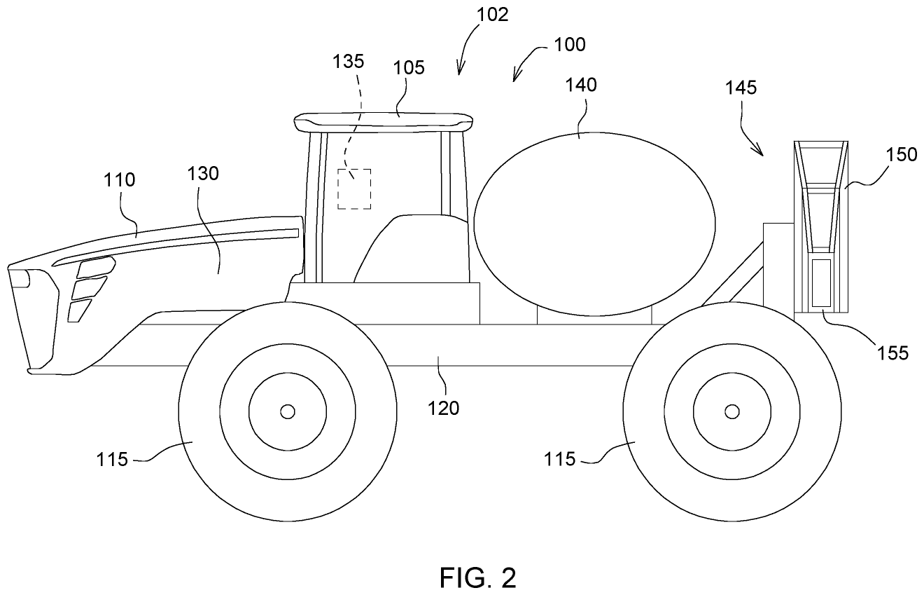

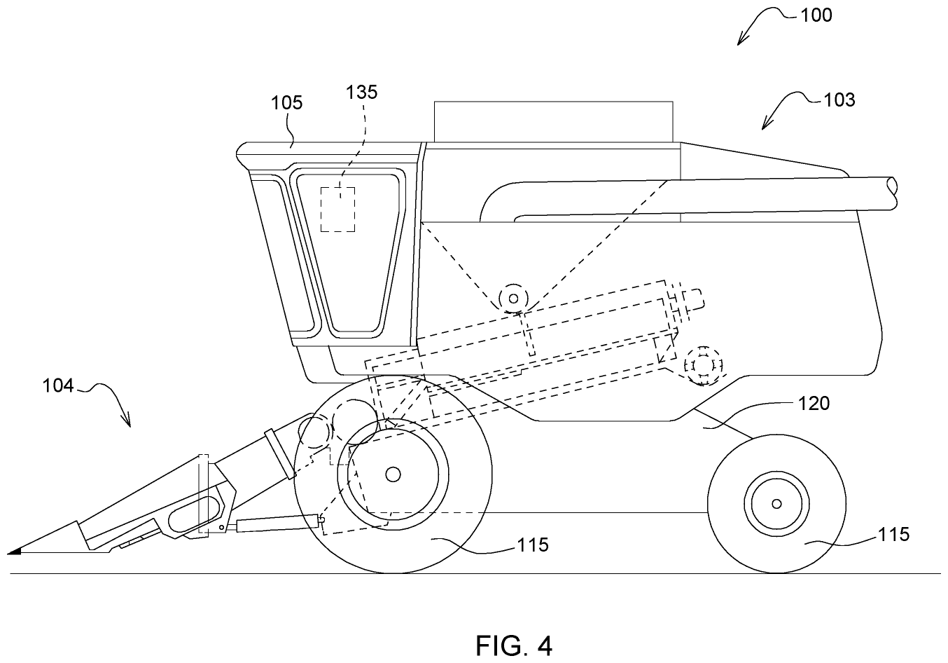

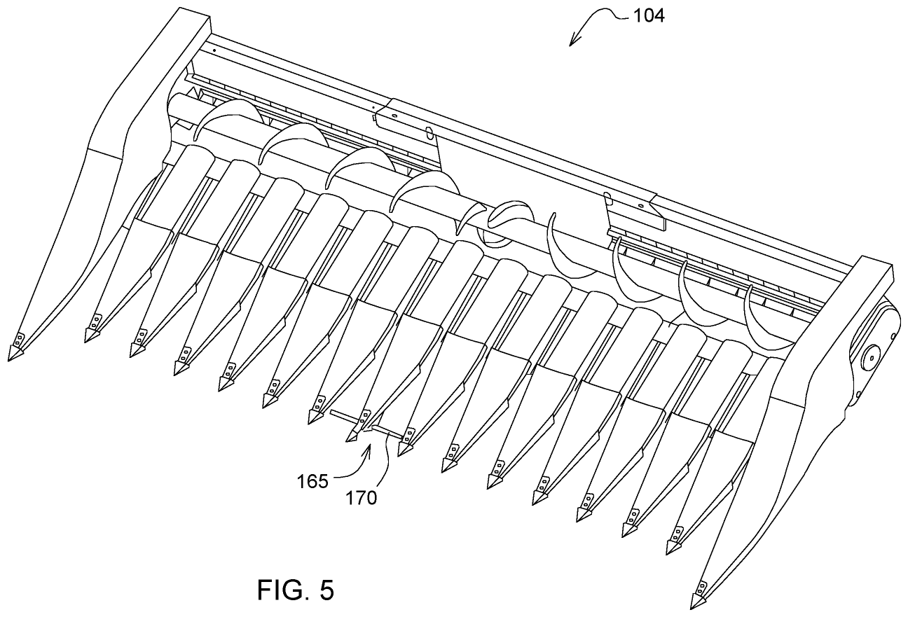

FIG. 1 illustrates an agricultural work vehicle 100, for example a tractor 101. This disclosure also contemplates that the agricultural work vehicle 100 can include an agricultural sprayer 102 (FIG. 2) or a combine harvester 103 (FIG. 4) with a header 104 (FIG. 5) 10 or other agricultural work vehicle 100. The agricultural work vehicle 100 can include an operator station or cab 105, a hood 110, one or more ground engaging apparatus 115, for example wheels or track assemblies, and a frame or chassis 120. The agricultural work vehicle 100 can have a rigid or an articulated frame 125. The agricultural work vehicle 100 can include one or more power sources 130, for example an internal combustion engine, a hybrid engine, or an electric or hydraulic motor. The agricultural work vehicle 100 can include an operator interface 135 having any number and combination of electronic devices, such as an interactive display for providing and receiving information and instructions to and from an operator. The agricultural work vehicle 100 can include a suspension system.

With regards to FIG. 2, the illustrated agricultural work vehicle 100 or agricultural sprayer 102 includes a tank 140 for storing a treatment (e.g., chemical) to be dispensed and a set of booms 145 for supporting one or more spray nozzles. Each boom 145 includes an inner boom portion 150 and an outer boom portion 155.

The agricultural work vehicle 100 can include a steering device 160 (FIG. 1) configured to steer the agricultural work vehicle 100. The steering device 160 can include a hydraulic cylinder 162 or other actuator.

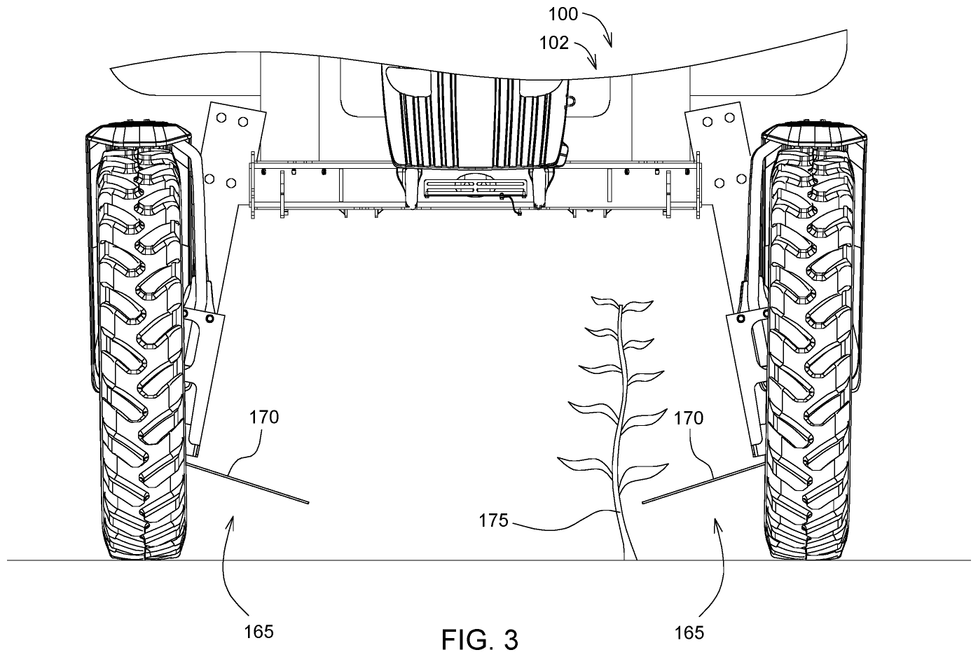

Referring to FIGS. 3 and 5, the agricultural work vehicle 100 can include a crop feeler device 165. The crop feeler device 165 can include a rod 170 configured to contact a crop 175. The rod 170 can be made of material that is rigid or semi-rigid in order to minimize flexing so that the rod 170 moves in a linear fashion.

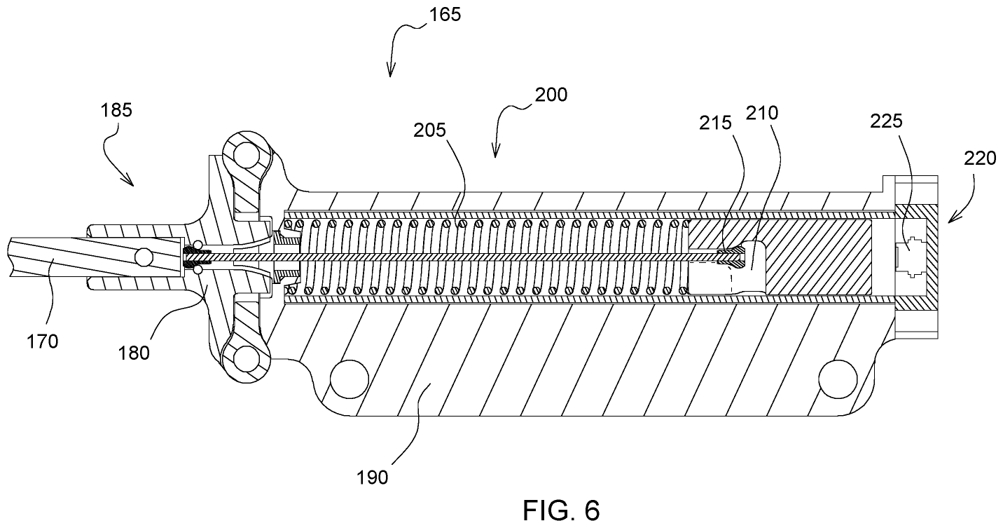

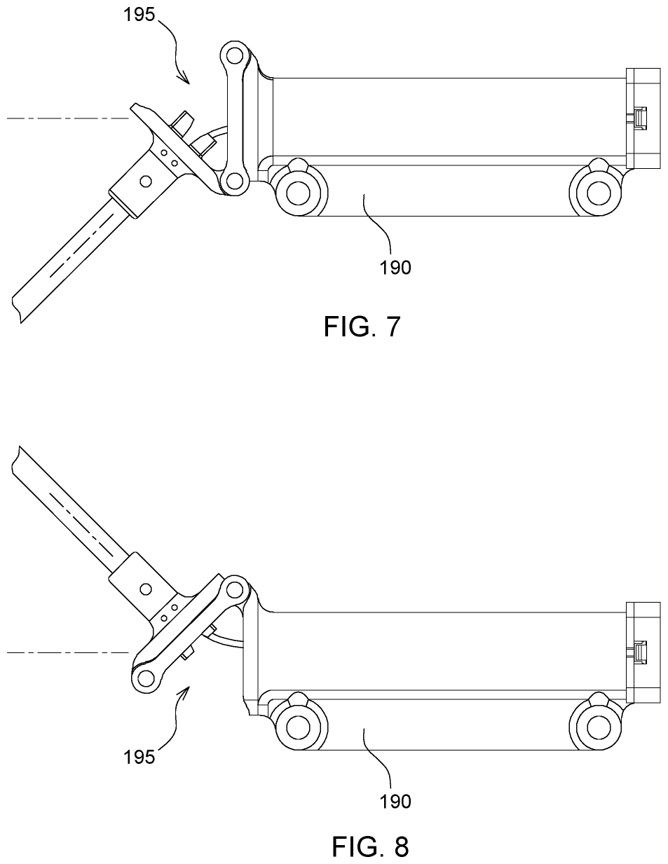

With reference to FIG. 6, a base 180 is coupled to the rod 170. The base 180 is configured to move from a first position 185, where the base 180 is not pivoted relative to a housing 190, to a second position 195 (FIG. 7), where the base 180 is pivoted relative to the housing 190 when the rod 170 is contacted by the crop 175.

The housing 190 is positioned in a facing relationship with the base 180. The base 180 is configured to pivot in two opposing directions relative to the housing 190 (FIGS. 7 and 8).

A compression device 200 is positioned within a portion of the housing 190. The compression device 200 can be a spring 205 or other compressive device. The compression device 200 can be compressed and is more compressed in the second position 195 than in the first position 185. When the load on the rod 170 is removed, the compression device 200 extends and returns the rod 170 to the first position 185.

A guide 210 is positioned within a portion of the housing 190 and in a facing relationship with the compression device 200.

A cable 215 is coupled to at least one of the rod 170 or the base 180 and to the guide 210. The cable 215 can pass through, or can be coupled to, the compression device 200 and pull the guide 210 toward the base 180 or otherwise compress the compression device 200 as the base 180 pivots relative to the housing 190.

A sensor 220 is positioned to measure a sensing distance from the sensor 220 to at least one of the guide 210, the cable 215, or the compression device 200 as the compression device 200 is compressed as the base 180 pivots relative to the housing 190, and provide a signal. A sensing distance is greater in the second position 195 than in the first position 185. The sensor 220 may comprise a laser 225. Alternatively, the sensor 220 may comprise any linear position sensor including linear variable differential transformer sensors and time of flight sensors. The sensor 220 can provide an output that is linear with respect to the movement of the guide 210, the cable 215, or the compression device 200, due to the rigidity of the rod 170. The output linearity enables the sensor 220 to provide measurements of the work vehicle 100 relative to the crop 175 that can be used to more accurately control the work vehicle 100 because the distance from the work vehicle 100 to the crop 175 is more accurately reflected in the sensor 220 output. The sensor 220 may be positioned inside the housing 190 to protect the sensor 220 from exposure to outside elements including water, dirt, debris, and the crop 175.

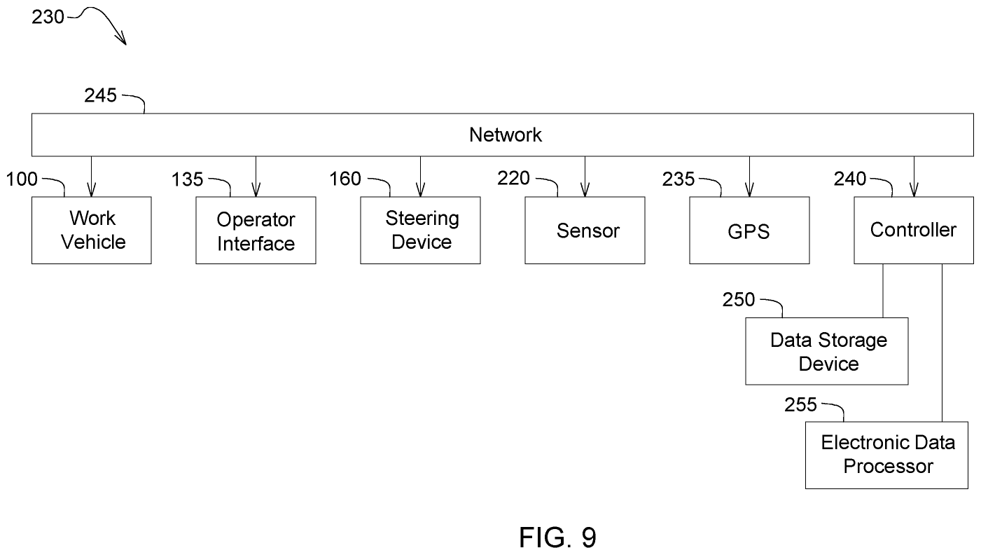

Referring to FIG. 9, a block diagram is provided of one example of a computing architecture 230 that includes the work vehicle 100, the sensor 220, a global positioning system (“GPS”) 235, and a controller 240. The GPS 235 may comprise a Global Navigation Satellite System (GNSS), a terrestrial radio triangulation system, or any other system which is able to provide the location of the work vehicle 100 in a field in global or local coordinates. The work vehicle 100, the operator interface 135, the steering device 160, the sensor 220, the GPS 235, and the controller 240 are connected over a network 245. Thus, computing architecture 230 operates in a networked environment, where the network 245 includes any of a wide variety of different logical connections such as a local area network (LAN), wide area network (WAN), controller area network (CAN) near field communication network, satellite communication network, cellular networks, or a wide variety of other networks or combination of networks. It is also noted that the controller 240 can be deployed on the work vehicle 100 such that the controller 240 performs the operations described herein without a networked connection such as via a wired connection.

The controller 240 may comprise a data storage device 250 and an electronic data processor 255. The data storage device 250 can be configured for storing instructions that are executable by the electronic data processor 255 to cause the electronic data processor 255 to receive the signal, determine a steering output, and provide a steering signal to the steering device 160, or otherwise control the hydraulic cylinder 162, to steer the agricultural work vehicle 100 so that the ground engaging apparatus 115 contacts a minimum amount of crop 175 or the agricultural work vehicle 100 damages a minimum amount of crop 175. Alternatively, the steering output may be determined to steer the agricultural work vehicle 100 so that the deflection sensed by the sensor 220 of one or more crop feeler devices 165 is the same or minimized. An operator may make a settings selection using the operator interface 135. The settings selection may include sensor 220 sensitivity, how much the steering output should be affected by how far the rod 170 is deflected, or other.

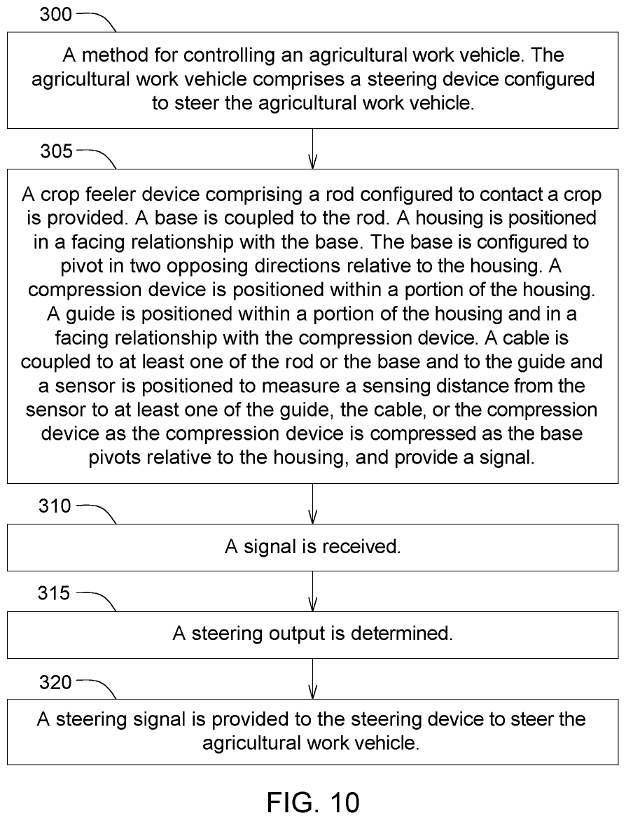

With reference to FIG. 10, a flow diagram of a method 300 for controlling an agricultural work vehicle 100 is provided. The agricultural work vehicle 100 comprises a steering device 160 configured to steer the agricultural work vehicle 100. At 305, a crop feeler device 165 comprising a rod 170 configured to contact a crop 175 is provided. A base 180 is coupled to the rod 170. A housing 190 is positioned in a facing relationship with the base 180. The base 180 is configured to pivot in two opposing directions relative to the housing 190. A compression device 200 is positioned within a portion of the housing 190. A guide 210 is positioned within a portion of the housing 190 and in a facing relationship with the compression device 200. A cable 215 is coupled to at least one of the rod 170 or the base 180 and to the guide 210 and a sensor 220 is positioned to measure a sensing distance from the sensor 220 to at least one of the guide 210, the cable 215, or the compression device 200 as the compression device 200 is compressed as the base 180 pivots relative to the housing 190, and provide a signal. At 310 a signal is received. At 315, a steering output is determined. At 320, a steering signal is provided to the steering device 160 to steer the agricultural work vehicle 100.

Various features are set forth in the following claims.

What is claimed is:

1. A crop feeler device comprising:
a rod;
a base coupled to the rod;
a housing positioned in a facing relationship with the base, the base configured to pivot in two opposing directions relative to the housing;
a compression device positioned within a portion of the housing;
a guide positioned within a portion of the housing and in a facing relationship with the compression device;
a cable coupled to at least one of the rod or the base and to the guide; and
a sensor positioned to measure a sensing distance from the sensor to at least one of the guide, the cable, or the compression device as the compression device is compressed as the base pivots relative to the housing.

2. The crop feeler device of claim 1, wherein the cable passes through the compression device and pulls the guide toward the base and compresses the compression device as the base pivots relative to the housing.

3. The crop feeler device of claim 1, wherein the base moves from a first position where the base is not pivoted relative to the housing to a second position where the base is pivoted relative to the housing when the rod is contacted by a crop.

4. The crop feeler device of claim 3, wherein the compression device is compressed more in the second position than in the first position.

5. The crop feeler device of claim 3, wherein the sensing distance is greater in the second position than in the first position.

6. The crop feeler device of claim 1, wherein the compression device comprises a spring.

7. The crop feeler device of claim 1, wherein the sensor comprises a laser.

8. The crop feeler device of claim 1, wherein the sensor provides an output that is linear with respect to the movement of the guide, the cable, or the compression device.

9. An agricultural work vehicle comprising:
a steering device configured to steer the agricultural work vehicle;
a crop feeler device comprising:
a rod configured to contact a crop;
a base coupled to the rod;
a housing positioned in a facing relationship with the base, the base configured to pivot in two opposing directions relative to the housing;
a compression device positioned within a portion of the housing;
a guide positioned within a portion of the housing and in a facing relationship with the compression device;
a cable coupled to at least one of the rod or the base and to the guide; and
a sensor positioned to measure a sensing distance from the sensor to at least one of the guide, the cable, or the compression device as the compression device is compressed as the base pivots relative to the housing, and provide a signal; and
a controller communicatively coupled to the sensor, the controller comprising a data storage device and an electronic data processor, the data storage device configured for storing instructions that are executable by the electronic data processor to cause the electronic data processor to receive the signal, determine a steering output, and provide a steering signal to the steering device to steer the agricultural work vehicle.

10. The agricultural work vehicle of claim 9, wherein the cable passes through the compression device and pulls the guide toward the base and compresses the compression device as the base pivots relative to the housing.

11. The agricultural work vehicle of claim 9, wherein the base moves from a first position where the base is not pivoted relative to the housing to a second position where the base is pivoted relative to the housing when the rod is contacted by a crop.

12. The agricultural work vehicle of claim 11, wherein the compression device is compressed more in the second position than in the first position.

13. The agricultural work vehicle of claim 11, wherein the sensing distance is greater in the second position than in the first position.

14. The agricultural work vehicle of claim 11, wherein the compression device comprises a spring.

15. The agricultural work vehicle of claim 11, wherein the sensor comprises a laser.

16. The agricultural work vehicle of claim 11, wherein the sensor provides an output that is linear with respect to the movement of the guide, the cable, or the compression device.

17. The agricultural work vehicle of claim 9, wherein the compression device comprises a spring.

18. The agricultural work vehicle of claim 9, wherein the sensor comprises a laser.

19. The agricultural work vehicle of claim 9, wherein the sensor provides an output that is linear with respect to the movement of the guide, the cable, or the compression device.

20. A method for controlling an agricultural work vehicle, the agricultural work vehicle comprising a steering device configured to steer the agricultural work vehicle, the method comprising:
providing a crop feeler device comprising a rod configured to contact a crop, a base coupled to the rod, a housing positioned in a facing relationship with the base, the base configured to pivot in two opposing directions relative to the housing, a compression device positioned within a portion of the housing, a guide positioned within a portion of the housing and in a facing relationship with the compression device, a cable coupled to at least one of the rod or the base and to the guide, and a sensor positioned to measure a sensing distance from the sensor to at least one of the guide, the cable, or the compression device as the compression device is compressed as the base pivots relative to the housing, and provide a signal;
receiving the signal;
determining a steering output; and
providing a steering signal to the steering device to steer the agricultural work vehicle.
